(19) United States
(12) Patent Application Publication
(10) Pub. No.: US 2013/0056034 A1
(43) Pub. Date: Mar. 7, 2013

(54) SELF DRIVEN ROTATING PULSE DETONATION CLEANING SYSTEM

(71) Applicants: Tian Xuan Zhang, Overland Park, KS (US); David Michael Chapin, Overland Park, KS (US)

(72) Inventors: Tian Xuan Zhang, Overland Park, KS (US); David Michael Chapin, Overland Park, KS (US)

(73) Assignee: BHA GROUP, Inc., Kansas City, MO (US)

(21) Appl. No.: 13/226,624

(22) Filed: Sep. 7, 2011

(51) Int. Cl. B08B 9/00

(52) U.S. Cl. 134/22.1; 134/166 R

(57) ABSTRACT

A pulse detonation device can provide one or more shock waves to an operating device. The pulse detonation device includes a pulse detonation chamber providing one or more shock waves, at least one pulse detonation outlet extending into the operating device and in operative association with the pulse detonation chamber, and a rotary union. The rotary union rotatably attaches the pulse detonation chamber to the at least one pulse detonation outlet, wherein the at least one pulse detonation outlet can move with respect to the pulse detonation chamber. The at least one pulse detonation outlet is rotatable within the operating device and can deliver the one or more shock waves to a plurality of locations within the operating device.

### BACKGROUND OF THE INVENTION

1. Field of the Invention

The invention relates to a cleaning device for agitating particles and, more particularly, to a pulse detonation device that delivers one or more shock waves to multiple locations within an operating device to agitate particles within the operating device.

2. Discussion of Prior Art

High-temperature operating devices may include baghouses, heat exchangers, boilers, selective catalytic reduction devices, etc. Particles, such as dust, dirt, combustion by-products, and the like, may accumulate on walls and structures within the high-temperature operating device. It can be difficult to remove particles that have accumulated on walls and/or structures within the operating device and may require taking the operating device out of service to clean it. Pulse detonation devices have been used to emit a shock wave in a variety of different applications. Delivering shock waves from the pulse detonation device into the operating devices can agitate the particles or structure, thus dislodging the particles from the surfaces of the operating device. However, the shock waves are limited in the distance from the exit of the pulse detonation device that they can effectively clean within the operating device. So, there can be a need to move the exit of the device in a manner to expand the area of influence of the shock waves that are being emitted. The addition of motor or other electro-mechanical rotating or linear driving devices to rotate/move the outlet of the shockwave delivering device leads to complexity for operation and maintenance of the device and is therefore undesirable. Thus, a simple method and device for increasing the surface area that the shock waves can impact would be beneficial. Furthermore, this method/device should be able to increase the surface area of the shock waves without increasing the power or space requirements of the pulse detonation device. Using the propulsive force generated by the shock producing device is a novel idea to simplify the operation and maintenance of the shock producing device.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect the present invention provides a pulse detonation device providing one or more shock waves to an operating device. The pulse detonation device includes a pulse detonation chamber configured to provide one or more shock waves, at least one pulse detonation outlet extending into the operating device and in operative association with the pulse detonation chamber, and a rotary union movably attaching the pulse detonation chamber to the at least one pulse detonation outlet, wherein the at least one pulse detonation outlet is configured in a manner to move with respect to the pulse detonation chamber. The at least one pulse detonation outlet is movable within the operating device and is configured to deliver the one or more shock waves to a plurality of locations within the operating device. This enhances the overall cleaning coverage of the shock cleaning system.

In accordance with another aspect the present invention provides a pulse detonation cleaning system including an operating device including an interior portion, a pulse detonation device in operative association with the operating device. The pulse detonation device includes a pulse detonation chamber configured to provide one or more shock waves, at least one pulse detonation outlet extending into the operating device and in operative association with the pulse detonation chamber, a rotary union rotatably attaching the pulse detonation chamber to the pulse detonation outlet, wherein the at least one pulse detonation outlet is configured to deliver the one or more shock waves to a plurality of locations within the operating device, and a rotation structure positioned on the at least one pulse detonation outlet, wherein the at least one pulse detonation outlet is positioned to self-drive the pulse detonation outlet through the rotation structure.

In accordance with another aspect of the present invention provides a method of providing a plurality of shock waves to multiple locations within an operating device, the method includes providing a pulse detonation chamber for producing one or more shock waves, providing at least one pulse detonation outlet extending into the operating device, attaching the at least one pulse detonation outlet to the pulse detonation chamber by a rotary union, wherein the at least one pulse detonation outlet is rotatable with respect to the pulse detonation chamber and within the operating device, directing the one or more shock waves to a plurality of locations within the operating device, and driving the rotation of the at least one pulse detonation outlet with a rotation structure located on the at least one pulse detonation outlet.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic side view, partially torn open, of an example operating device with an example pulse detonation device shown;

FIG. 2 is a sectional side view of the example operating device of FIG. 1 with the example pulse detonation device shown;

FIG. 3 is a cross-sectional side view of the example operating device of FIG. 2 taken along section line 3-3 of FIG. 2;

FIG. 4 is a sectional side view of the example operating device with a second example pulse detonation device shown;

FIG. 5 is a cross-sectional side view of the example operating device of FIG. 4 taken along section line 5-5 of FIG. 4;

FIG. 6 is a sectional side view of the example operating device with a third example pulse detonation device shown;

FIG. 7 is a cross-sectional side view of the example operating device of FIG. 6 taken along section line 7-7 of FIG. 6;

FIG. 8 is a sectional side view of the example operating device with a fourth example pulse detonation device shown; and

FIG. 9 is a cross-sectional side view of the example operating device of FIG. 8 taken along section line 9-9 of FIG. 8.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

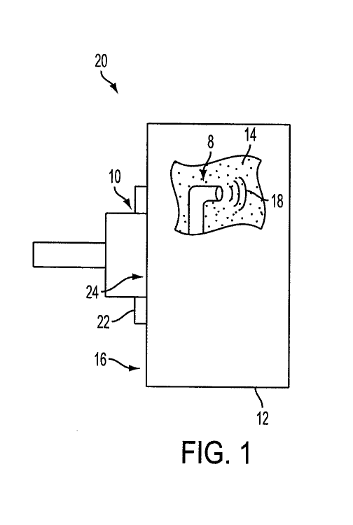

FIG. 1 illustrates a pulse detonation cleaning system 10 according to one aspect of the invention. The pulse detonation cleaning system 10 may include one or more pulse detonation devices 20 associated with an operating device 12. Within the shown example, the pulse detonation device 20 includes a single pulse detonation device associated with the operating device 12.

It is to be appreciated that the operating device 12 is only generically/schematically shown and may be varied in construction and function. The operating device 12 may include a variety of devices including, but not limited to, boilers, heat exchangers, selective catalyst reduction (SCR), electrostatic precipitator (ESP), silos, hoppers, bin sidewalls, air preheater baskets, baghouses, cooling towers, spray towers, fans, etc. Similarly, the operating device 12 can vary between a wide range of high-temperatures depending on the device. For instance, the operating device can be at ambient temperature or up to 2000° F. In fact, depending on the specific application, the operating device can withstand temperatures of 3,000 Kelvin to 4,000 Kelvin or higher. As such, the operating device 12 need not be a specific limitation upon the present invention.

The operating device 12 is defined by one or more walls 16 surrounding an interior portion 14 provided within the operating device 12. The operating device 12 may further include one or more openings 24 extending through the one or more walls 16. In the shown examples, there is one opening, however, it is to be understood, that more than one opening may be provided. The openings 24 can provide an opening for the pulse detonation device 20 to extend into the interior portion 14 of the operating device 12.

Particles 8, such as dust, dirt, ash, soot, or the like, may accumulate on the walls 16 or structures (not shown), such as liquid carrying heat exchangers or tubes/pipes, of the interior portion 14 of the operating device 12. The removal of particles 8 can help to increase the operating efficiency of the operating device. Particles 8 accumulating on the walls and/or structures of the interior portion 14 can be more difficult to remove while the operating device is online (operating). Therefore, an example of the pulse detonation device 20 can be used to agitate the particles in the operating device 12 by providing one or more shock waves 18 to the interior portion 14 of the operating device 12 while the operating device is in operation. Once agitated, the particles are dislodged from the walls and/or structure within the interior portion 14 and, once airborne, can be more easily removed from the operating device 12 through normal processes used in such devices. The shock waves 18 can also (or only) vibrate the walls 16 and/or structures within the interior portion 14 to crack, dislodge, and/or remove the accumulated particles.

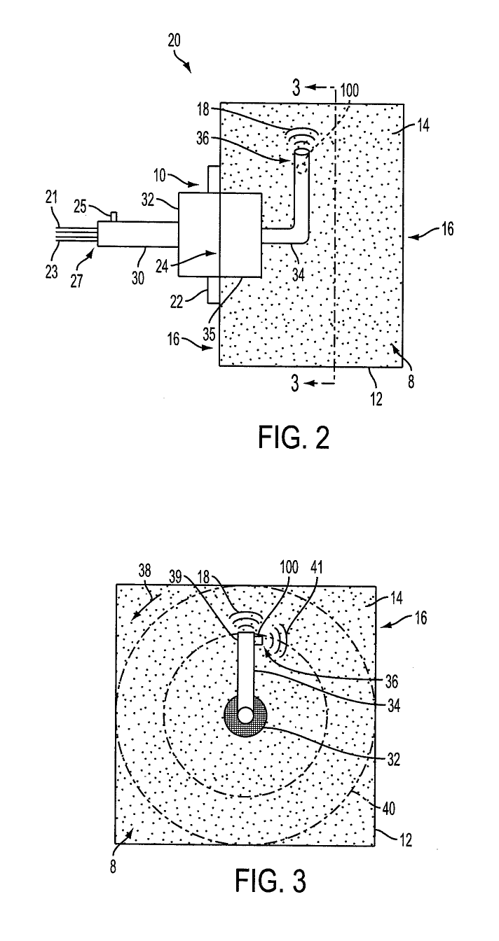

Referring now to FIG. 2, the interior portion 14 of the operating device 12 is shown. An example of the pulse detonation device 20 is shown in attachment with the wall 16 of the operating device 12. The pulse detonation device 20 can include a fuel inlet 21 in operative association with a pulse detonation chamber 30. The fuel inlet 21 can deliver fuel to the pulse detonation chamber 30 such that the delivered fuel will be burned in the pulse detonation chamber 30. It is to be understood that the term ‘fuel’ can encompass a variety of different fuels. For instance, the fuel inlet 21 can deliver either a liquid fuel or a non-liquid fuel, such as a gas. Furthermore, the fuel inlet 21 can deliver ethylene, propane, methane, hydrogen, or the like. The fuel inlet 21 can be operatively attached to a fuel supply source at an end opposite from the pulse detonation chamber 30. The fuel inlet 21 can include a tube, pipe, conduit, or any other suitable tubing for delivering the fuel from the fuel supply source to the pulse detonation chamber 30.

The pulse detonation device 20 can further include an oxidizer or air inlet 23 in operative association with the pulse detonation chamber 30. The air inlet 23 can deliver air or compressed air, such as pure oxygen, an oxygen combination, or atmospheric air, to the pulse detonation chamber 30. The air inlet 23 can be operatively attached to an air supply source at an end opposite from the pulse detonation chamber 30. For instance, the air inlet 23 can be operatively attached to an air compressor that provides pressurized air to the air inlet 23. Similar to the fuel inlet 21, the air inlet 23 can include a tube, pipe, conduit, or any other suitable tubing for delivering air.

The fuel inlet 21 and air inlet 23 can deliver fuel and air, respectively, from an external source to the pulse detonation chamber 30. The fuel and air can mix either in the pulse detonation chamber 30, or at a location before reaching the pulse detonation chamber 30. For instance, a conduit (not shown) can be included from the fuel inlet 21 and air inlet 23 to the pulse detonation chamber 30. The conduit can transport the fuel and air together, as a mixture, or separately, such that the fuel and air mix upon entering the pulse detonation chamber 30.

The pulse detonation chamber 30 can further include an ignition device 25. The ignition device 25 can be positioned along a wall near, but in front of, an inlet end 27 of the pulse detonation chamber 30. Accordingly, by positioning the ignition device 25 at a distance from the inlet end 27, the fuel and air can mix prior to flowing past the ignition device 25. The ignition device 25 can include a number of structures known in the art, such as a spark plug, spark discharge, heat source, or the like. The ignition device 25 can be connected to a controller in order to operate the ignition device 25 at desired times.

In the shown example of FIG. 2, the pulse detonation chamber 30 is shown with respect to the wall 16 of the operating device 12. The pulse detonation chamber 30 can receive the fuel and air mixture to create a shock wave 18 (schematically represented). The pulse detonation chamber 30 can be an elongated tube with a hollow center. The hollow center defines a combustion chamber. The pulse detonation chamber 30 can be of any length, and is not limited to the length in the shown example. Moreover, the pulse detonation chamber 30 can include a variety of shapes, such as a circular shape, oval shape, square shape, etc.

The operation of the pulse detonation chamber 30 can now be described. The combustion of the fuel and air mixture by the ignition device 25 can produce shock waves 18 that propagate through the pulse detonation chamber 30. The fuel and air can mix either prior to entering the pulse detonation chamber 30, or upon entering the pulse detonation chamber 30 at the inlet end 27. As more fuel and air are introduced and mixed in the pulse detonation chamber 30, the pulse detonation chamber 30 can fill with the fuel/air mixture, starting at the inlet end 27 and progressing along the pulse detonation chamber 30. A controller (not shown) can track the amount of fuel/air mixture in the tube and can close a valve to stop the flow of the fuel and/or air into the pulse detonation chamber 30 after an amount of time has passed. The ignition device 25 can be triggered by a controller to initiate the combustion of the fuel/air mixture by providing a spark, or other ignition source, to the pulse detonation chamber 30. The spark can create a flame within the fuel/air mixture near the ignition device 25. The flame can consume the fuel/air mixture by burning it and, as such, the flame will propagate and accelerate through the fuel/air mixture within the pulse detonation chamber 30 in such a way to create a strong shock wave.

The flame propagating through the pulse detonation chamber 30 creates a relatively high temperature and pressure environment to produce the shock wave 18. Pressure can increase behind the shock wave 18 to drive the shock wave away from the inlet end 27 of the pulse detonation chamber 30. The shock wave 18 travels down the length of the pulse detonation chamber 30 and can travel at high speeds, such as from Mach 2 to Mach 5. Similarly, the pressure immediately behind the shock wave 18 can also be high, such as 18 to 30 times the initial pressure. For instance, if the shock wave 18 is traveling through an atmospheric pressure vessel, the pressure immediately behind the shock wave 18 could be 18-30 times atmospheric pressure. The temperature immediately behind the shock wave 18 can also be high. Depending on the specific application and the fuel/air mixture, the flame temperature can range from 3,000 Kelvin to 4,000 Kelvin. The speed at which this combustion takes place is so fast that hot combustion products further behind the shock wave also are at elevated pressure, but not as high as the pressure of the shock wave itself mentioned above. When the shock wave 18 exits the pulse detonation device 20, the high-pressure by-products of the combustion can escape through the same detonation outlet, thus providing a short thrust force. This thrust force can be used to drive the rotation of the pulse detonation device 20 described herein.

As used herein, the pulse detonation device 20 can refer to a device and/or system that produces either or both a pressure rise and a velocity increase from the detonation or quasi-detonation of a fuel and oxidizer. The pulse detonation device 20 can be operated in a repeating mode to produce multiple detonations or quasi-detonations within the device. A detonation is a supersonic combustion in which a shock wave is coupled to a combustion zone, and the shock is sustained by the energy release from the combustion zone, resulting in combustion products at a higher pressure than the combustion reactants. For simplicity, the term “detonation” can include both detonations and quasi-detonations. A quasi-detonation can include a supersonic turbulent combustion process that produces a pressure rise and velocity increase higher than a pressure rise and velocity increase produced by a sub-sonic deflagration wave.

It is to be understood that the pulse detonation device 20 and the pulse detonation chamber 30 shown in the examples from FIGS. 1-9 is only generically/schematically shown and may be varied in construction and function. As such, the pulse detonation chamber 30 shown in the examples is not intended to be a limitation on the present invention. Instead, the pulse detonation chamber can include a variety of pulse detonation chambers and devices that are known in the art. For instance, in one example, the pulse detonation chamber 30 could include multiple deflecting surfaces causing the shock wave to deflect in multiple directions before exiting the pulse detonation chamber.

Referring still to FIG. 2, the pulse detonation chamber 30 is shown attached to a rotary union 32. The rotary union 32 can be attached to the wall 16 of the operating device 12. The pulse detonation chamber 30 can be in operative association with the rotary union 32. As will be described below, the rotary union 32 can rotatably attach a pulse detonation outlet 34 to the pulse detonation chamber 30. In addition to the rotatable attachment, the rotary union 32 can further provide for the passage of the shock wave 18 to travel from the pulse detonation chamber 30 through the rotary union 32 and to the pulse detonation outlet 34. It is to be appreciated that rotary unions are generally known in the art, and that the rotary union 32 in the shown example is only generically/schematically shown and may be varied in construction and function. For instance, a variety of rotary unions could be used in the present example to rotatably attach the pulse detonation outlet 34 to the pulse detonation chamber 30. Similarly, the rotary union 32 can be formed from a number of temperature and pressure resistant materials, such that the rotary union 32 can be used in the operating device 12 listed above and any of the various operating devices listed herein. For instance, since the flame temperature can rise to 3,000 Kelvin to 4,000 Kelvin, the rotary union 32 could be formed from a material capable of withstanding these temperatures.

In the shown example, the pulse detonation chamber 30 can be inserted or attached to one end of the rotary union 32, such that the pulse detonation chamber 30 is held in place by the rotary union 32. The pulse detonation chamber 30 can be attached to the rotary union 32 in a number of ways, including threading engagement, snap fit attachment, etc. In one example, the pulse detonation chamber 30 is fixed in place with respect to the rotary union 32 and does not move. However, it is contemplated that the pulse detonation chamber 30 can be rotatably attached to the rotary union 32.

The rotary union 32 can be attached to the wall 16 such that a portion of the rotary union 32 can be positioned flush with the wall 16 or extend at least partially into the interior portion 14 of the operating device 12. In one example, the rotary union 32 can extend at least partially through the one or more openings 24 extending through the one or more walls 16. An attachment means or structure, such as a flange, male-female threading attachment, a snap fit attachment, etc. may hold the rotary union 32 in place against the wall 16. In the shown example, a flange 22 can be provided to attach the rotary union 32 to the wall 16. The flange 22 may include one or more screws (not shown) for engaging corresponding openings in the wall 16. Thus, the rotary union 32 can be removably attachable to the wall 16.

The rotary union 32 can further include an indexing device 35. The indexing device 35 can be attached to the rotary union 32 and to the pulse detonation outlet 34. The indexing device 35 can allow for a controlled, incremental rotation of the pulse detonation outlet 34 with respect to the pulse detonation chamber 30. The indexing device 35 can allow for the pulse detonation outlet 34 to rotate a certain, predetermined distance with respect to the pulse detonation chamber 30. For instance, the indexing device 35 can be set to allow for a certain rotation angle, such as 10° in a clockwise direction. Accordingly, the indexing device 35 can allow for each rotation to be 10° clockwise. In operation, the pulse detonation outlet 34 can rotate a first time 10° clockwise. After another shock wave 18 is released from the pulse detonation outlet 34, the indexing device 35 can allow for a second 10° rotation clockwise. The incremental rotations can continue along an entire 360° range of motion. As such, the pulse detonation outlet 34 can be limited in the maximum amount of rotation for each rotation, such that the pulse detonation outlet 34 will not freely rotate and can be controllably rotated. It is to be understood that angles and directions other than 10° clockwise are contemplated, and that the present example is not limited to the angles and directions described herein.

Referring still to FIG. 2, the pulse detonation outlet 34 can be rotatably attached to the rotary union 32 through the indexing device 35. As such, the pulse detonation outlet 34 can rotate with respect to the pulse detonation chamber 30. Furthermore, during the rotation, the pulse detonation outlet 34 can receive the shock wave 18 from the pulse detonation chamber 30. The shock wave 18 can travel from the pulse detonation chamber 30, through the rotary union 32, to the pulse detonation outlet 34, and into the operating device 12. The pulse detonation outlet 34 can extend at least partially into the interior portion 14 of the operating device 12. The pulse detonation outlet 34 can be an elongated tube defining a hollow center that extends axially along the length of the pulse detonation outlet 34. Accordingly, upon attachment, the pulse detonation outlet 34 can incrementally rotate with respect to the rotary union 32 while the rotary union 32 and pulse detonation chamber 30 remain in place.

The pulse detonation outlet 34 may take on a number of different shapes, depending on a number of factors, including the specific application, the location of the surface to be cleaned, the shape of the operating device 12, etc. The pulse detonation outlet 34 can be a linearly or non-linearly shaped elongated tube. For instance, the pulse detonation outlet 34 can be substantially linear in shape, such as having a straight section, or can further include one or more bends or curves and be non-linear in shape, as will be discussed below. In the shown example of FIG. 2, the pulse detonation outlet 34 can include one bend having a substantially 90° turn. As such, the pulse detonation outlet 34 can be directed toward an interior portion of the wall 16 of the operating device 12.

Referring now to FIG. 3, a cross-sectional view of operating device 12 is shown. Specifically, the pulse detonation outlet 34 is shown in operative association with the interior portion 14 of the operating device 12. The pulse detonation outlet 34 can further include an exit portion 39 positioned towards the end of the pulse detonation outlet 34. The exit portion 39 can define a substantially open end of the pulse detonation outlet 34. The exit portion 39 can be substantially linearly shaped. As such, the shock wave 18 can be formed in the pulse detonation chamber 30, travel through the pulse detonation chamber 30 and through the rotary union 32, through the pulse detonation outlet 34, and out of the exit portion 39 and into the interior portion 14 of the operating device 12. The shock wave 18 can engage and agitate particles or structures in the interior portion 14 that are floating in the air, resting on structures, resting on the walls 16, etc.

Referring still to FIG. 3, the pulse detonation outlet 34 is rotatably attached to the rotary union 32 such that the pulse detonation outlet 34 can rotate with respect to the pulse detonation chamber 30. Accordingly, the pulse detonation outlet 34 can rotate within the operating device 12. The pulse detonation outlet 34 can rotate along a path 40, such as a substantially circular path. As the pulse detonation outlet 34 rotates, the pulse detonation chamber 30 can continuously and repeatedly deliver the shock waves 18. For instance, the pulse detonation chamber 30 can continuously deliver a succession of shock waves 18 that travel to the pulse detonation outlet 34. Accordingly, as the pulse detonation outlet 34 rotates along the path 40, the shock waves 18 can continuously exit from the exit portion 39 and engage any structures or walls 16 within the operating device 12. As such, as the pulse detonation outlet 34 rotates, the shock waves 18 can engage a plurality of locations on the walls 16 along the path 40 within the operating device 12, thus providing a larger coverage area. In the shown example, the pulse detonation outlet 34 can rotate in a direction 38, such as a counterclockwise direction. It is to be understood, however, that the pulse detonation outlet 34 could alternately rotate in an opposite direction, such as clockwise, and/or a combination of both directions.

The pulse detonation outlet 34 can include a rotation structure 36 positioned on the at least one pulse detonation outlet. The rotation structure 36 can cause the rotation of the pulse detonation outlet 34 due to the outlet orientation of the rotation structure 36 with respect to the rotation axis of the system, thus allowing the pulse detonation outlet 34 to be self-driven.

In the example shown in FIG. 3, the rotation structure 36 can include a nozzle 100. The nozzle 100 can cause rotation of the pulse detonation outlet 34, thus allowing the pulse detonation outlet 34 to be self-driven. The nozzle 100 can include a hole, opening, or the like positioned on a side of the pulse detonation outlet 34. The nozzle 100 can take on a number of different sizes and shapes. For instance, the nozzle 100 can include a square hole, circular hole, rectangular hole, etc. Similarly, the nozzle 100 can be larger or smaller than in the shown example of FIG. 2 and could be positioned at a number of locations along the pulse detonation outlet 34, such as closer to the end, etc. The nozzle 100 can allow the pulse detonation outlet 34 to rotate in the direction 38. When the shock wave 18 travels through the pulse detonation outlet 34, at least some of the shock wave can exit through the nozzle 100, shown as an exiting shock wave 41. The remainder of the shock wave can exit through the exit portion 39, shown as the shock wave 18. The exiting gases exiting the nozzle 100 can provide momentum to the pulse detonation outlet 34. As such, this momentum, in the form of a reaction force can cause the pulse detonation outlet 34 to rotate in the direction 38 that is opposite to the direction of travel that the exiting shock wave 41 leaves the nozzle 100.

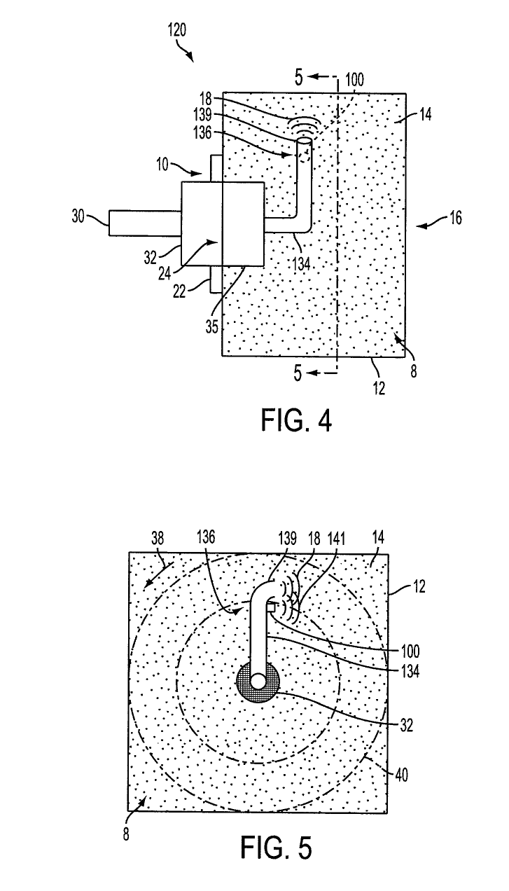

Referring now to FIG. 4, a second example of a pulse detonation device 120 is shown with a pulse detonation outlet 134 including an exit portion 139. The exit portion 139 in the shown example can be non-linearly shaped (shown in FIG. 5). As with the example shown in FIG. 2, the pulse detonation outlet 134 can be rotatably attached to the rotary union 32 such that the pulse detonation outlet 134 can again rotate with respect to the pulse detonation chamber 30. Similarly, the rotary union 32 can include the indexing device 35. The indexing device 35 can allow for the pulse detonation outlet 134 to rotate a certain, predetermined distance with respect to the pulse detonation chamber 30.

During the rotation, the pulse detonation outlet 134 can receive the shock wave 18 from the pulse detonation chamber 30. The pulse detonation outlet 134 can extend at least partially into the interior portion and can define an elongated tube with a hollow center that extends axially along the length of the pulse detonation outlet 134. The attachment of the pulse detonation outlet 134 to the rotary union 32 can be substantially the same as the example of FIG. 2, including threading engagement, snap fit attachment, etc.

Referring now to FIG. 5, a cross-sectional view of the operating device 12 is shown, with the pulse detonation outlet 134 in operative association with the interior portion 14 of the operating device 12. The pulse detonation outlet 134 can include the exit portion 139 positioned towards the end of the pulse detonation outlet 134. The exit portion 139 can define a substantially open end of the pulse detonation outlet 134. In contrast to the example shown in FIG. 2, the exit portion 139 can be non-linearly shaped. For instance, the exit portion 139 can include an elbow exit portion that is bent. As such, by having a bent portion forming the elbow exit portion, the direction of the shock waves 18 can be different than the direction shown in FIG. 2. Accordingly, the shock wave 18 can again be formed in the pulse detonation chamber 30, travel through the pulse detonation chamber 30 and through the rotary union 32, through the pulse detonation outlet 134, and out of the exit portion 139 shaped as the elbow exit portion, and into the interior portion 14 of the operating device 12. The shock wave 18 can engage and agititate particles in the interior portion 14 that are floating in the air, resting on structures, resting on the walls 16, etc.

Referring still to FIG. 5, the pulse detonation outlet 134 can be rotatably attached to the rotary union 32 such that the pulse detonation outlet 134 can rotate with respect to the pulse detonation chamber 30. The pulse detonation outlet 134 can again rotate in a path 40, such as a substantially circular path. As the pulse detonation outlet 134 rotates, the pulse detonation chamber 30 can continuously deliver a succession of shock waves 18 that travel to the pulse detonation outlet 134. Accordingly, as the pulse detonation outlet 134 rotates along the path 40, the shock waves 18 can continuously exit from the exit portion 139 and engage any structures or walls 16 within the operating device 12. As such, the shock waves 18 can engage a plurality of locations of the walls 16 along the path 40 as the pulse detonation outlet 134 rotates. Consequently, the pulse detonation device 120 can continuously and repeatedly deliver the shock waves 18 to a variety of locations within the operating device 12, thus providing a larger coverage area.

In the shown example, the pulse detonation outlet 134 can include a rotation structure 136 positioned on the pulse detonation outlet 134. In the shown example, the rotation structure 136 can include the elbow exit portion. The rotation structure can cause the rotation of the pulse detonation outlet 134, thus allowing the pulse detonation outlet 134 to be self-driven. For instance, as is well known in the art, Newton's second law generally states that in the absence of external forces, the total momentum of a body is conserved. Accordingly, when the shock wave 18 passes through the pulse detonation outlet 134 and out of the exit portion 139, the shock wave 18 is followed by hot pressure gases. When the shock wave leaves the exit portion 139, the gases are released and the pulse detonation outlet 134 will move in the direction 38 that is opposite to the direction of travel of those gases, but equal in momentum to that of the gases. As such, the total momentum of the pulse detonation outlet 134 will be zero as the pulse detonation outlet 134 is rotated. In the shown example of FIG. 5, each shock wave 18 exits the elbow portion of the rotation structure 136 and travels in a clockwise direction, thus causing the pulse detonation outlet 134 to rotate in the direction 38 that is counterclockwise. Continuously emitted shock waves can cause continuous rotation of the pulse detonation outlet 134. As will be described below, the rotation structure 136 is not limited to the elbow exit portion, and multiple structures and methods can be used to cause self-driven rotation of the pulse detonation outlet.

The rotation structure 136 can further include the nozzle 100. The nozzle 100 can contribute to the rotation of the pulse detonation outlet 134, thus allowing the pulse detonation outlet 134 to be self-driven. The nozzle 100 can be substantially identical to the nozzle 100 shown and described above with respect to FIG. 3. As such, the description of the nozzle 100 in FIG. 5 is the same as the description of the nozzle 100 in FIG. 3, and need not be repeated. The nozzle 100 can be oriented such that an exiting shock wave 141 can cause the pulse detonation outlet 134 to rotate in the direction 38.

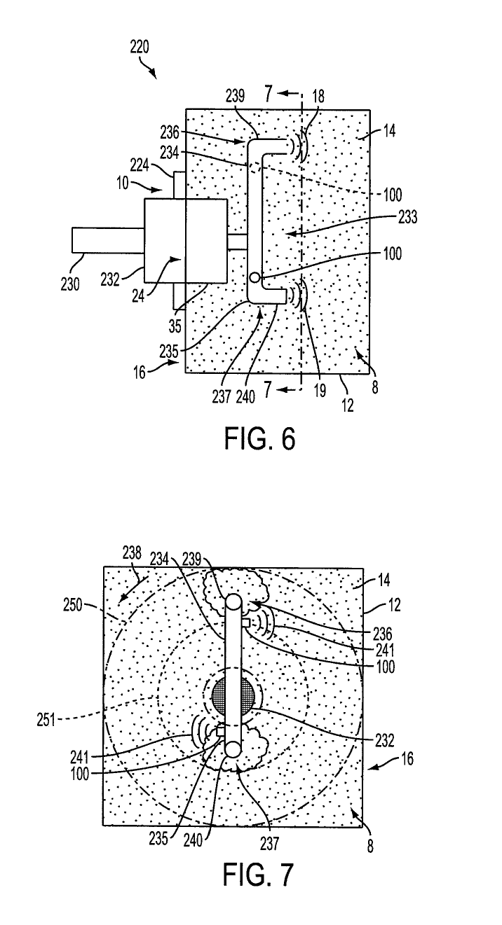

Referring now to FIG. 6, an example of a pulse detonation device 220 is shown with a plurality of pulse detonation outlets. While the pulse detonation device can include one pulse detonation outlet, as shown in FIGS. 2 to 5, the pulse detonation device could further include two pulse detonation outlets, as shown in FIGS. 6 to 9, or more pulse detonation outlets. The pulse detonation device 220 can include a pulse detonation chamber 230. The pulse detonation chamber 230 can be substantially similar to the pulse detonation chamber described in the examples of FIGS. 2 to 5. Similarly, the operation of the pulse detonation chamber 230 can be substantially identical to the operation of the pulse detonation chambers described in the examples of FIGS. 2 to 5 or similar to any of the examples of pulse detonation chambers described herein.

In the shown example of FIG. 6, the pulse detonation device 220 can be in operative association with the operating device 12 through a multi-path rotary union 232. The pulse detonation chamber 230 can be attached to the multi-path rotary union 232 such that the pulse detonation chamber 230 remains fixed in place with respect to the multi-path rotary union 232. In the alternative, the pulse detonation chamber 230 can be rotatably attached to the multi-path rotary union 232. The pulse detonation chamber 230 can be inserted or attached to one end of the multi-path rotary union 232, such that the pulse detonation chamber 230 is held in place by the multi-path rotary union 232. The pulse detonation chamber 230 can be attached to the multi-path rotary union 232 in a number of ways, including threading engagement, snap fit attachment, etc.

The multi-path rotary union 232 can provide for the passage of the shock wave 18 to travel from the pulse detonation chamber 230 through the multi-path rotary union 232 and into the operating device 12. Similar to the examples described with respect to FIGS. 2 to 5, the multi-path rotary union 232 can be attached adjacent to the wall 16 such that a portion of the multi-path rotary union 232 can be positioned flush with the wall 16 or extend at least partially into the interior portion 14 of the operating device 12. In this example, the multi-path rotary union 232 can extend at least partially through one or more openings extending through the walls 16. An attachment means or structure, such as a flange, male-female threading attachment, a snap fit attachment, etc. may hold the multi-path rotary union 232 in place against the wall 16. In the shown example, a flange 224 can be provided to attach the multi-path rotary union 232 to the wall 16. The flange 224 may include one or more screws (not shown) for engaging corresponding openings in the wall 16. Thus, the multi-path rotary union 232 can be removably attachable from the wall 16.

It is to be appreciated that multi-path rotary unions are generally known in the art, and the multi-path rotary union 232 in the shown example is only generically/schematically shown and may be varied in construction and function. For instance, a variety of multi-path rotary unions could be used in the present example to rotatably attach a pulse detonation outlet 233 to the pulse detonation chamber 230. Similarly, the multi-path rotary union 232 can be formed from a number of temperature and pressure resistant materials, such that the multi-path rotary union 232 can be used in the operating device 12 listed above.

As with the previous examples, the multi-path rotary union 232 can further include the indexing device 35. The indexing device 35 can be attached to the multi-path rotary union 232 and to the pulse detonation outlet 233. The indexing device 35 can allow for a controlled, incremental rotation of the pulse detonation outlet 233 with respect to the pulse detonation chamber 230. The indexing device 35 can allow for the pulse detonation outlet 233 to rotate a certain, predetermined distance with respect to the pulse detonation chamber 30. For instance, as described above, the indexing device 35 can be set to allow for a certain rotation angle, such as 10° in a clockwise direction. Accordingly, the indexing device 35 can allow for each rotation to be 10° clockwise. In operation, the pulse detonation outlet 233 can rotate a first time 10° clockwise. After another shock wave 18 is released from the pulse detonation outlet 34, the indexing device 35 can allow for a second 10° rotation clockwise. The incremental rotations can continue along an entire 360° range of motion. As such, the pulse detonation outlet 233 can be limited in the maximum amount of rotation for each rotation, such that the pulse detonation outlet 233 will not freely rotate and can be controllably rotated. It is to be understood that angles and directions other than 10° clockwise are contemplated, and that the present example is not limited to the angles and directions described herein.

Referring still to FIG. 6, the pulse detonation outlet 233 can be rotatably attached to the multi-path rotary union 232 through the indexing device 35. As such, the pulse detonation outlet 233 can rotate with respect to the pulse detonation chamber 230. During the rotation, the pulse detonation outlet 233 can receive the shock wave 18 from the pulse detonation chamber 230. The pulse detonation outlet 233 can extend at least partially into the interior portion 14 of the operating device 12. Accordingly, upon attachment, the pulse detonation outlet 233 can incrementally rotate with respect to the multi-path rotary union 232 while the multi-path rotary union 232 and pulse detonation chamber 230 remain in place.

The pulse detonation outlet 233 can be an elongated tube defining a hollow center that extends axially along the length of the pulse detonation outlet 233. In the shown example, the pulse detonation outlet 233 can include a first pulse detonation outlet 234 and a second pulse detonation outlet 235. The pulse detonation outlet 233 can branch off at a location downstream from the indexing device 35 to form the first pulse detonation outlet 234 and the second pulse detonation outlet 235. Each of the first pulse detonation outlet 234 and the second pulse detonation outlet 235 can take on a number of different sizes and shapes, depending on a number of factors, including the specific application, the location of the surface to be cleaned, and the shape of the operating device 12. Similarly, each of the first pulse detonation outlet 234 and the second pulse detonation outlet 235 can be a linearly or non-linearly shaped elongated tube. For instance, the first pulse detonation outlet 234 and the second pulse detonation outlet 235 can each be substantially linear in shape, such as having a straight section, and/or can further include one or more bends or curves and be non-linear in shape, as will be discussed below. In the shown example of FIG. 6, the first pulse detonation outlet 234 and the second pulse detonation outlet 235 can each include one bend having a substantially 90° turn. As such, the first pulse detonation outlet 234 and the second pulse detonation outlet 235 can both be directed toward an interior portion of the wall 16 of the operating device 12.

Referring now to FIG. 7, a cross-sectional view of the operating device 12 is shown, with the pulse detonation outlet 233 in operative association with the interior portion 14 of the operating device 12. The pulse detonation outlet 233 can include the first pulse detonation outlet 234 and the second pulse detonation outlet 235 having different lengths. For instance, in the shown example, the first pulse detonation outlet 234 can have a longer length than the second pulse detonation outlet 235. The first pulse detonation outlet 234 can be positioned with a first exit portion 239 closer to the wall 16. Similarly, the second pulse detonation outlet 235 can be positioned with a second exit portion 240 farther from the wall 16 and closer to the multi-path rotary union 232. It is to be understood, however, that the individual lengths of the first pulse detonation outlet 234 and the second pulse detonation outlet 235 can be varied and are not limited to the lengths shown here. For instance, the individual lengths of the first pulse detonation outlet 234 and the second pulse detonation outlet 235 can be predetermined based on the application and the location of the desired cleaning area.

The first pulse detonation outlet 234 and second pulse detonation outlet 235 can include a first rotation structure 236 and second rotation structure 237, respectively. The rotation structures 236, 237 can cause the rotation of the first pulse detonation outlet 234 and second pulse detonation outlet 235, thus allowing the pulse detonation outlet 233 to be self-driven. In the shown example, the rotation structures 236, 237 can each include a nozzle 100. The nozzle 100 can include a hole, opening, or the like positioned on a side of either or both of the pulse detonation outlet 234, 235. The nozzle 100 can take on a number of different sizes and shapes. For instance, the nozzle 100 can include a square hole, circular hole, rectangular hole, etc. Similarly, the nozzle 100 can be larger or smaller than in the shown example and could be positioned at a number of locations along the first pulse detonation outlet 234 and second pulse detonation outlet 235, such as closer to the end, etc. The nozzle 100 can allow the pulse detonation outlet 233 to rotate in a direction 238. When the shock wave travels through the first pulse detonation outlet 234 and second pulse detonation outlet 235, at least some of the shock wave can exit through the nozzle 100, shown as an exiting shock wave 241. The remainder of the shock wave can exit through a first exit portion 239 and second exit portion 240 as a shock wave 18 and second shock wave 19, respectively. In the shown example, the exiting gases exiting the nozzle 100 can provide momentum to both the first pulse detonation outlet 234 and second pulse detonation outlet 235. As such, this momentum can cause the pulse detonation outlet 233 to rotate in the direction 238 that is opposite to the direction of travel that the exiting shock wave 241 leaves the nozzles 100.

Referring still to FIG. 7, in operation, the rotational attachment between the pulse detonation outlet 233 and the multi-path rotary union 232 can allow the pulse detonation outlet 233 and, thus, the first pulse detonation outlet 234 and the second pulse detonation outlet 235, to rotate with respect to the pulse detonation chamber 230 and the multi-path rotary union 232. Similar to the examples shown in FIGS. 2 to 5, the first pulse detonation outlet 234 and the second pulse detonation outlet 235 can rotate within the operating device 12. The first pulse detonation outlet 234 and the second pulse detonation outlet 235 can rotate in the direction 238 forming two substantially circular paths, a first path 250, and a second path 251. The first path 250 can have a larger diameter than the second path 251. The first path 250 can define the circular rotation of travel of the first exit portion 239 of the first pulse detonation outlet 234. Accordingly, the first path 250 can define the path that the shock waves 18 are emitted from the first exit portion 239. The shock waves 18 can thereby engage a plurality of locations of the walls 16 along the first path 250. Similarly, the second path 251 can define the circular rotation of travel of the second exit portion 240 of the second pulse detonation outlet 235. The second path 251 can define the path that the second shock waves 19 are emitted from the second exit portion 240. The second shock waves 19 can thereby engage a plurality of locations of the walls 16 along the second path 251. In the shown example, the first exit portion 239 and second exit portion 240 are directed towards the wall 16 that is opposite of the multi-path rotary union 232. As such, the shock waves 18, 19 can be repeatedly delivered to engage a plurality of locations of the wall along the first path 250 and the second path 251. The pulse detonation device 220 can continuously and repeatedly deliver the shock waves 18, 19 to a larger coverage area within the operating device 12.

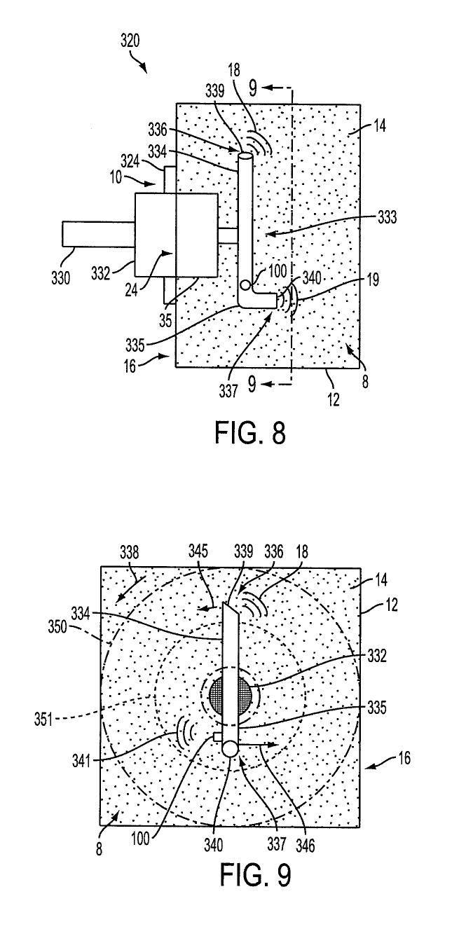

Referring now to FIG. 8, an example of a pulse detonation device 320 is shown with a plurality of pulse detonation outlets. Similar to the example shown in FIG. 6, the pulse detonation device 320 can include a pulse detonation chamber 330. The structure and operation of the pulse detonation chamber 330 can be substantially identical to the pulse detonation chamber described in the examples of FIGS. 2 to 7.

In the shown example of FIG. 8, the pulse detonation device 320 can be in operative association with the operating device 12 through a multi-path rotary union 332. The pulse detonation chamber 330 can be attached to the multi-path rotary union 332 such that the pulse detonation chamber 330 remains fixed in place with respect to the multi-path rotary union 332. In the alternative, the pulse detonation chamber 330 can be rotatably attached to the multi-path rotary union 332. The pulse detonation chamber 330 can be inserted or attached to one end of the multi-path rotary union 332, such that the pulse detonation chamber 330 is held in place by the multi-path rotary union 332. The pulse detonation chamber 330 can be attached to the multi-path rotary union 332 in a number of ways, including threading engagement, snap fit attachment, etc. Similarly, the multi-path rotary union 332 can include the indexing device 35. The indexing device 35 can be identical to the indexing device 35 described above with respect to FIGS. 2-7. As such, the description of the indexing device 35 with respect to FIGS. 2-7 also applies to the example shown in FIGS. 8 and 9. The indexing device 35 can allow for a pulse detonation outlet 333 to rotate a certain, predetermined distance with respect to the pulse detonation chamber 330.

The multi-path rotary union 332 can provide for the passage of the shock wave 18 to travel from the pulse detonation chamber 330 through the multi-path rotary union 332 and into the operating device 12. Similar to the examples shown in FIGS. 2 to 7, the multi-path rotary union 332 can be attached adjacent to the wall 16 such that a portion of the multi-path rotary union 332 can be positioned flush with the wall 16 or extend at least partially into the interior portion 14 of the operating device 12. In this example, the multi-path rotary union 332 can extend at least partially through one or more openings extending through the walls 16. An attachment means or structure, such as a flange, male-female threading attachment, a snap fit attachment, etc. may hold the multi-path rotary union 332 in place against the wall 16. In the shown example, a flange 324 can be provided to attach the multi-path rotary union 332 to the wall 16. The flange 324 may include one or more screws (not shown) for engaging corresponding openings in the wall 16. Thus, the multi-path rotary union 332 can be removably attachable from the wall 16.

It is to be appreciated that multi-path rotary unions are generally known in the art, and the multi-path rotary union 332 in the shown example is only generically/schematically shown and may be varied in construction and function. For instance, a variety of multi-path rotary unions could be used in the present example to rotatably attach a pulse detonation outlet 333 to the pulse detonation chamber 330. Similarly, the multi-path rotary union 332 can be formed from a number of temperature and pressure resistant materials, such that the multi-path rotary union 332 can be used in the operating device 12 listed above or any of the various operating devices listed herein.

Similar to the example shown in FIG. 6, the pulse detonation outlet 333 can be an elongated tube defining a hollow center that extends axially along the length of the pulse detonation outlet 333. In the shown example, the pulse detonation outlet 333 can include a first pulse detonation outlet 334 and a second pulse detonation outlet 335. The pulse detonation outlet 333 can branch off at a location downstream from the multi-path rotary union 332 to form the first pulse detonation outlet 334 and the second pulse detonation outlet 335. Each of the first pulse detonation outlet 334 and the second pulse detonation outlet 335 can take on a number of different sizes and shapes, depending on a number of factors, including the specific application, the location of the surface to be cleaned, and the shape of the operating device 12. Similarly, each of the first pulse detonation outlet 334 and the second pulse detonation outlet 335 can be a linear or non-linear elongated tube. For instance, the first pulse detonation outlet 334 and the second pulse detonation outlet 335 can each be substantially linear in shape, such as having a straight section, and/or can further include one or more bends or curves and be non-linear in shape, as will be discussed below.

Referring now to FIG. 9, a cross-sectional view of the operating device 12 is shown, with the pulse detonation outlet 333 in operative association with the interior portion 14 of the operating device 12. The first pulse detonation outlet 334 and the second pulse detonation outlet 335 can have different of lengths. For instance, in the shown example, the first pulse detonation outlet 234 can have a longer length than the second pulse detonation outlet 335. The first pulse detonation outlet 334 can be positioned with a first exit portion 339 closer to the wall 16. Similarly, the second pulse detonation outlet 335 can be positioned with a second exit portion 340 farther from the wall 16 and closer to the multi-path rotary union 332. It is to be understood, however, that the individual lengths of the first pulse detonation outlet 334 and the second pulse detonation outlet 335 can be varied and are not limited to the lengths shown here. For instance, the individual lengths of the first pulse detonation outlet 334 and the second pulse detonation outlet 335 can be predetermined based on the application and the location of the desired cleaning area.

Referring still to FIG. 9, in operation, the rotational attachment between the pulse detonation outlet 333 and the multi-path rotary union 332 can allow the pulse detonation outlet 333 and, thus, the first pulse detonation outlet 334 and the second pulse detonation outlet 335, to rotate with respect to the pulse detonation chamber 330 and the multi-path rotary union 332. Similar to the examples shown in FIGS. 6 and 7, the first pulse detonation outlet 334 and the second pulse detonation outlet 335 can rotate within the operating device 12. The first pulse detonation outlet 334 and the second pulse detonation outlet 335 can rotate in a direction 338 forming two substantially circular paths, a first path 350, and a second path 351. The first path 350 can have a larger diameter than the second path 351. The first path 350 can define the circular rotation of travel of the first exit portion 339 of the first pulse detonation outlet 334. Accordingly, the first path 350 can define the path that the shock waves 18 are emitted from the first exit portion 339. The shock waves 18 can thereby engage a plurality of locations of the walls 16 along the first path 350. Similarly, the second path 351 can define the circular rotation of travel of the second exit portion 340 of the second pulse detonation outlet 335. The second path 351 can define the path that second shock waves 19 are emitted from the second exit portion 340. The second shock waves 19 can thereby engage a plurality of locations of the walls 16 along the second path 351. In the shown example, the first exit portion 339 and second exit portion 340 are directed towards the walls that are adjacent and/or opposite of the multi-path rotary union 332. As such, the shock waves 18, 19 can be repeatedly delivered to engage a plurality of locations of the walls along the first path 350 and the second path 351. As such, the pulse detonation device 320 can continuously and repeatedly deliver shock waves 18, 19 to a larger coverage area within the operating device 12.

Referring still to FIG. 9, the first pulse detonation outlet 334 can include a first rotation structure 336. The first rotation structure 336 can include an angled exit portion. The first rotation structure 336 can cause the rotation of the first pulse detonation outlet 334, thus allowing the first pulse detonation outlet 334 to be self-driven. As stated above with regard to Newton's second law, when the shock wave 18 passes through the first pulse detonation outlet 334 and out of the first exit portion 339, the shock wave 18 it is followed by high pressure gases that propel the rotation. When the shock wave leaves the first exit portion 339, the first pulse detonation outlet 334 will move due to a reaction force 345 opposite to the direction of travel of the gases but equal in momentum to that of the gases. As such, the total momentum of the first pulse detonation outlet 334 will be zero as the first pulse detonation outlet 334 is rotated. In the shown example, the first rotation structure 336 is the angled exit portion, such that each shock wave 18 that exits the first exit portion 339 can cause the first pulse detonation outlet to rotate in a direction 338 that is counterclockwise. Continuous shock waves can cause further continuous rotation of the first pulse detonation outlet 334.

Referring still to FIG. 9, the second pulse detonation outlet 335 can include a second rotation structure 337. The second rotation structure 337 can include a nozzle 100. The second rotation structure 337 can cause the rotation of the second pulse detonation outlet 335, thus allowing the second pulse detonation outlet 335 to be self-driven. The nozzle 100 can include a hole, opening, or the like positioned on a side of the second pulse detonation outlet 335. The nozzle 100 can take on a number of different sizes and shapes. For instance, the nozzle 100 can include a square hole, circular hole, rectangular hole, etc. Similarly, the nozzle 100 can be larger or smaller than in the shown example of FIG. 9 and could be positioned at a number of locations along the second pulse detonation outlet 335, such as closer to the end, etc. The nozzle 100 can allow the second pulse detonation outlet 335 to rotate in the direction 338. When the shock wave travels through the second pulse detonation outlet 335, at least some of the shock wave can exit through the nozzle 100, shown as an exiting shock wave 341. As shown in FIG. 8, the remainder of the shock wave can exit through a second exit portion 340 as a second shock wave 19. In the shown example of FIG. 9, the exiting gases exiting the nozzle 100 can provide momentum to the second pulse detonation outlet 335. As such, this momentum, in the form of a reaction force 346 can cause the second pulse detonation outlet 335 to rotate in the direction 338 that is opposite to the direction of travel that the exiting shock wave 341 leaves the nozzle 100.

Accordingly, the pulse detonation outlet 333 can be self-driven to rotate by either or both of the rotation structures of the respective pulse detonation outlets. It is to be understood, however, that any of the example pulse detonation outlets shown in FIGS. 2 to 9 could include any of the rotation structures described herein. For instance, some or all of the rotation structures shown could include a nozzle, an angled exit portion, and/or an elbow exit portion. As such, with regard to the examples in FIGS. 2 to 5 showing a single pulse detonation outlet, the rotation structure 36, 136 of any of the pulse detonation outlet 34, 134 can include either a nozzle, angled exit portion, or elbow exit portion, such that the pulse detonation outlet 34, 134 can be self-driven. Similarly, with regard to the examples in FIGS. 6 to 9 showing multiple pulse detonation outlets 234, 235, 334, 335, each of the rotation structures 236, 236, 336, 337 of the pulse detonation outlets 234, 235, 334, 335 could include either a nozzle, angled exit portion, or elbow exit portion, such that the pulse detonation outlets 234, 235, 334, 335 could be self-driven. Further, the rotation structures are not limited to the examples disclosed herein, and could take the form of any other rotation structures configured to allow the pulse detonation outlet to be self-driven to rotate.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

1-20. (canceled)

21. A pulse detonation device providing one or more shock waves to an operating device, the pulse detonation device comprising:
a pulse detonation chamber configured to provide one or more shock waves;
at least one pulse detonation outlet extending into the operating device and in operative association with the pulse detonation chamber; and
a rotary union movably attaching the pulse detonation chamber to the at least one pulse detonation outlet, wherein the at least one pulse detonation outlet is configured to move with respect to the pulse detonation chamber;
wherein the at least one pulse detonation outlet is movable within the operating device and is configured to deliver the one or more shock waves to a plurality of locations within the operating device upon moving from a first position to a second position.

22. The pulse detonation device of claim 21, wherein the pulse detonation outlet is self-driven to move by a rotation structure of the pulse detonation outlet.

23. The pulse detonation device of claim 22, wherein the rotation structure includes a nozzle.

24. The pulse detonation device of claim 22, wherein the rotation structure includes an angled exit portion.

25. The pulse detonation device of claim 22, wherein the rotation structure includes an elbow exit portion.

26. The pulse detonation device of claim 21, further including an indexing device in operative association with the rotary union and the at least one pulse detonation outlet, wherein the indexing device is configured to provide incremental rotation of the pulse detonation outlet with respect to the pulse detonation chamber.

27. The pulse detonation device of claim 21, wherein the rotary union includes a multi-path rotary union.

28. The pulse detonation device of claim 27, wherein the at least one pulse detonation outlet includes a first pulse detonation outlet and a second pulse detonation outlet, further wherein the multi-path rotary union rotatably attaches the first pulse detonation outlet and the second pulse detonation outlet to the pulse detonation chamber.

29. The pulse detonation device of claim 28, wherein the first pulse detonation outlet has a longer length than the second pulse detonation outlet.

30. The pulse detonation device of claim 29, wherein the first pulse detonation outlet and the second pulse detonation outlet are self-driven to move by at least one rotation structure, wherein the at least one rotation structure is positioned on at least one of the first pulse detonation outlet and the second pulse detonation outlet.

31. A pulse detonation cleaning system comprising:
an operating device including an interior portion;
a pulse detonation device in operative association with the operating device, the pulse detonation device including:
a pulse detonation chamber configured to provide one or more shock waves;
at least one pulse detonation outlet extending into the operating device and in operative association with the pulse detonation chamber;
a rotary union rotatably attaching the pulse detonation chamber to the pulse detonation outlet, wherein the at least one pulse detonation outlet is configured to deliver the one or more shock waves to a plurality of locations within the operating device; and
a rotation structure positioned on the at least one pulse detonation outlet, wherein the at least one pulse detonation outlet is self-driven to move by the rotation structure.

32. The pulse detonation cleaning system of claim 31, wherein the rotation structure includes a nozzle.

33. The pulse detonation cleaning system of claim 31, wherein the rotation structure includes an angled exit portion.

34. The pulse detonation cleaning system of claim 31, wherein the rotation structure includes an elbow exit portion.

35. The pulse detonation cleaning system of claim 31, wherein the at least one pulse detonation outlet is configured to move in a substantially circular path.

36. The pulse detonation cleaning system of claim 31, wherein the at least one pulse detonation outlet includes a first pulse detonation outlet and a second pulse detonation outlet, further wherein a multi-path rotary union attaches the first pulse detonation outlet and the second pulse detonation outlet to the pulse detonation chamber.

37. The pulse detonation cleaning system of claim 36, wherein the first pulse detonation outlet has a longer length than the second pulse detonation outlet.

38. The pulse detonation cleaning system of claim 37, wherein the first pulse detonation outlet and the second pulse detonation outlet are self-driven to move by the rotation structure, wherein the rotation structure is positioned on at least one of the first pulse detonation outlet and the second pulse detonation outlet.

39. A method of providing a plurality of shock waves to multiple locations within an operating device, the method including:
providing a pulse detonation chamber for producing one or more shock waves;
providing at least one pulse detonation outlet extending into the operating device;
attaching the at least one pulse detonation outlet to the pulse detonation chamber by a rotary union, wherein the at least one pulse detonation outlet is rotatable with respect to the pulse detonation chamber and within the operating device;
directing the one or more shock waves to a plurality of locations within the operating device; and
driving the rotation of the at least one pulse detonation outlet with a rotation structure located on the at least one pulse detonation outlet.
